(19) United States
(12) Patent Application Publication
(10) Pub. No.: US 2008/0156193 A1
(43) Pub. Date: Jul. 3, 2008

(54) PORTABLE PSA OXYGEN GENERATOR

(76) Inventor: Dong-lei WANG, Zhuhai City (CN)

Correspondence Address: CARSTENS & CAHOON, LLP, P O BOX 802334, DALLAS, TX, 75380, US

(21) Appl. No.: 11/962,565

(22) Filed: Dec. 21, 2007

(30) Foreign Application Priority Data
Dec. 31, 2006 (CN) 200620155692.8

(51) Int. Cl. B01D 53/047

(52) U.S. Cl. 96/112

(57) ABSTRACT

The present invention relates to a portable pressure swing adsorption (“PSA”) oxygen generator with at least one partition board disposed inside its housing; an oil-free compressor and a control valve assembly are disposed in one of the separated space isolated by at least one fixing board and the at least one partition board; wherein a fan is disposed inclined or vertically on the partition board outside of the isolated space so that air can be blown into the isolated space directly by an air outlet of the fan. The present invention is built in compact structure with small size and light weight to carry and move, and works safely with a choice of three different types of power supplies, which enable the oxygen generator of the present invention to be used more widely than conventional ones.

### TECHNICAL FIELD

The present utility model relates to a portable pressure swing adsorption (“PSA”) oxygen generator.

### BACKGROUND OF THE INVENTION

Along with the rapid development of science technology, the pace of life and work in modern society is faster and faster, accordingly people have to do more brain works, and office workers are more likely to have negative physiological reactions such as headache; in addition, our living environment is getting worse due to the rapid industry development, and many areas are affected by serious air pollutions. In order to improve the environment and people's health, oxygen therapy and oxygen healthcare are very important and irreplaceable with broad development prospects. For those people under long-term oxygen therapy and oxygen healthcare treatment, they prefer to have a new type of medical oxygen generator which can be carried and moved easily with small size and light weight and which can work safely and economically with a choice of different types of power supplies. Nowadays, oxygen cylinders, oxygen bags, chemical oxygen generators and mini PSA oxygen generators are mainly used but they have the following disadvantages: (1) Although oxygen cylinders and oxygen bags can be carried easily, there are potential safety risks during intake of oxygen, and continuous oxygen supply is not available since oxygen cylinders and oxygen bags are pressure vessels; (2) chemical oxygen generators are in small size with light weight but they can not be reused when they are finished, also they cost expensively to people under long-term oxygen therapy and oxygen healthcare treatment, since extra chemicals should be added periodically; (3) mini PSA oxygen generators can be used at home, but for those people who often go out, they can not be carried easily because they are larger in size with heavy weight and should be supplied only with alternating current.

### SUMMARY OF THE INVENTION

The present utility model is to solve the problems of prior art technology by providing a portable PSA oxygen generator, which is built in compact structure with small size and light weight to carry and move, and works safely with a choice of three different types of power supplies, which enable the oxygen generator of the present utility model to be used more widely than conventional ones.

The goal of the present utility model is achieved by the following technical scheme:

A portable PSA oxygen generator comprising:

a housing, a fixing board, a partition board, and components including: an air filter assembly including a filter and an air-intaking muffler, an oil-free compressor, a control valve assembly, a PSA oxygen generating assembly including absorbing tanks and an ventilating muffler, an oxygen supply assembly including an oxygen tank, a pressure reducing valve and a filter, a heat dissipation assembly including a fan and a temperature controller, and an electric control assembly including a PCB board, pressure & oxygen sensors, a negative pressure sensor and a rechargeable battery; characterized in that, at least one fixing board is disposed inside the housing which divide an interior of the housing into one or more separated spaces, so that said components are disposed within said one or more separated spaces by the sides of the at least one fixing board.

The oxygen generator of the present utility model comprises the heat dissipation assembly; the oil-free compressor and the control valve assembly are disposed in one of the separated spaces isolated by the partition board; the fan is disposed inclined or vertically so that air can be blown into the isolated space directly; ambient air is blown by the fan from an air inlet of the housing into the oxygen tank, then into the pressure reducing valve, the PCB board and the absorbing tanks, etc, finally the air is blown by the fan into an isolated space to go through the ventilating muffler to be exhausted with useless air from an air outlet of the housing or directly exhausted.

The control valve assembly consists of at least four micro two-position two-way electromagnetic valves which are connected in parallel, or consists of one or more micro two-position five-way pilot-operated air control valves which are connected in parallel.

The PSA oxygen generating assembly includes two or more absorbing tanks which are connected in parallel.

The electric control assembly provides a choice of different types of power supplies including a rechargeable battery, a regulated power supply and a vehicle power supply.

The heat dissipation assembly includes a temperature controller so as to prevent the working temperature inside the oxygen generator from exceeding a threshold value.

The ventilating muffler is disposed in another separated space isolated by another partition board so as to exhaust nitrogen easily.

A fixed or detachable handle and belt lock catches are disposed on the housing for the convenience of carrying the whole oxygen generator easily.

The present utility model has the following advantages: it is built in small size and light weight of ≦5 kg, also it can be carried easily and works with a choice of three different types of power supplies, therefore, it is suitable for hospitals, homes, offices, public entertainment places, plateau regions and air-conditioned vehicles.

### BRIEF DESCRIPTION OF THE DRAWINGS

FIG. 1 is a structural view of a portable PSA oxygen generator of the present utility model;

FIG. 1-1 is a right view of the oxygen generator as shown in FIG. 1;

FIG. 1-2 is a left view of the oxygen generator as shown in FIG. 1;

FIG. 2 is a schematic view showing heat dissipation and air ventilation of the oxygen generator.

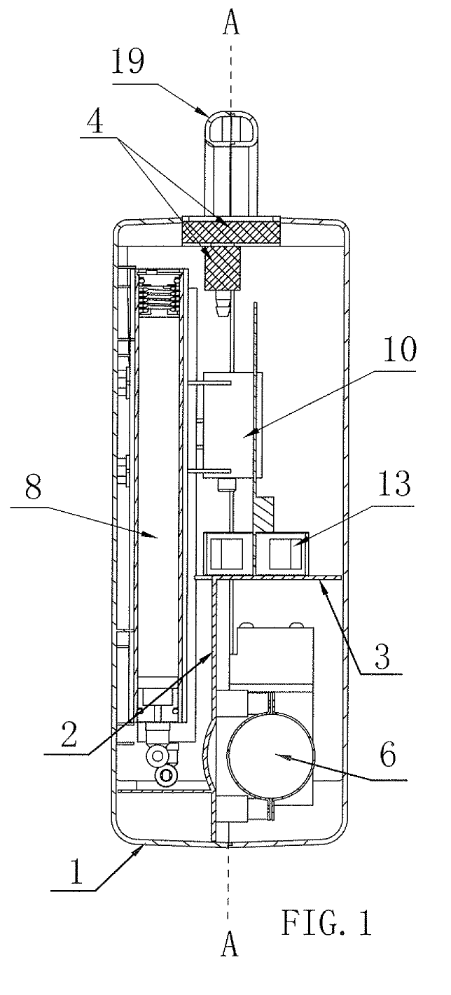

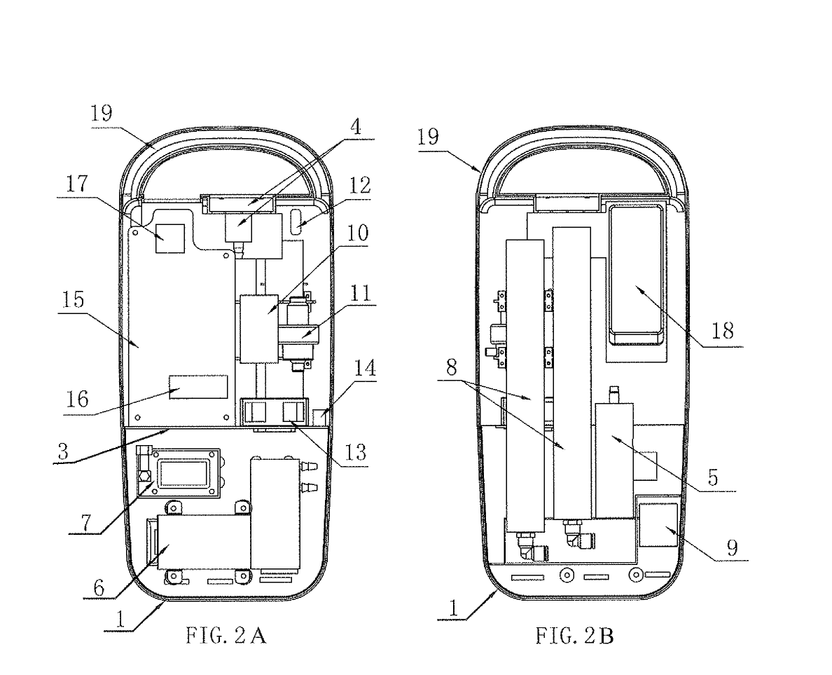

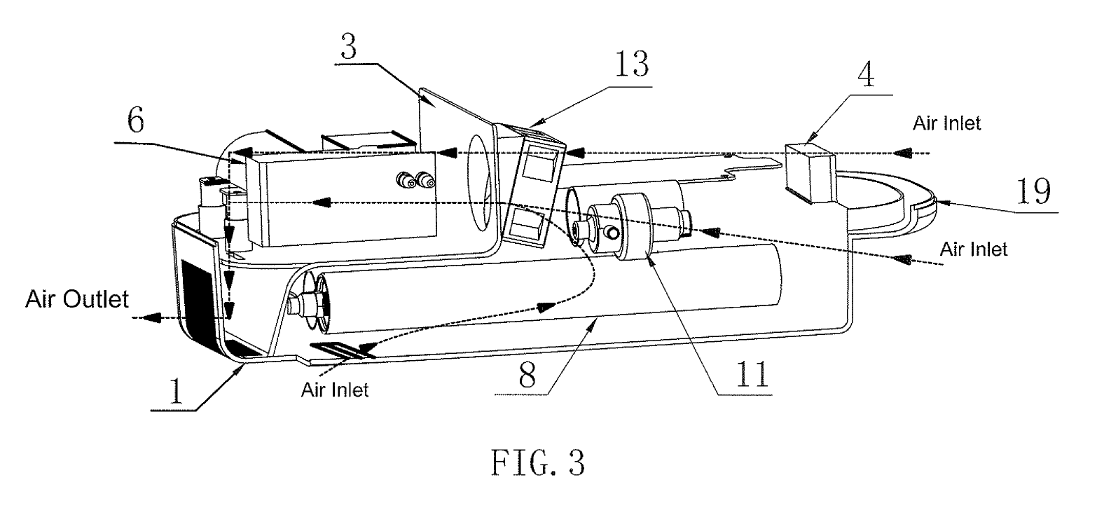

### DETAILED DESCRIPTION OF THE PREFERRED EMBODIMENTS

Detailed description of the present utility model will be made in combination with the appended drawings, in which: a portable PSA oxygen generator comprises: a housing 1, a fixing board 2, a partition board 3, and components including: an air filter assembly including a filter 4 and an air-intaking muffler 5, an oil-free compressor 6, a control valve assembly 7, a PSA oxygen generating assembly including absorbing tanks 8 and an ventilating muffler 9, an oxygen supply assembly including an oxygen tank 10, a pressure reducing valve 10 and a filter 12, a heat dissipation assembly including a fan 13 and a temperature controller 14, and an electric control assembly including a PCB board 15, pressure & oxygen sensors 16, a negative pressure sensor 17 and a rechargeable battery 18.

The oxygen generator comprise the housing 1, at least one fixing board 2 is disposed inside the housing 1 which divide an interior of the housing 1 into one or more separated spaces, so that said components are disposed within said one or more separated spaces by the sides of the at least one fixing board 2.

The oxygen generator of the present utility model comprises the heat dissipation assembly; the oil-free compressor 6 and the control valve assembly 7 are disposed in one of the separated spaces isolated by the partition board 3; the fan 13 is disposed inclined or vertically so that air can be blown into the isolated space directly; ambient air is blown by the fan from an air inlet of the housing 1 into the oxygen tank 10, then into the pressure reducing valve 11, the PCB board 15 and the absorbing tanks 8, etc, finally the air is blown by the fan 13 into an isolated space to go through the ventilating muffler 9 to be exhausted with useless air from an air outlet of the housing or directly exhausted.

The control valve assembly 7 consists of at least four micro two-position two-way electromagnetic valves which are connected in parallel, or consists of one or more micro two-position five-way pilot-operated air control valves which are connected in parallel for controlling the air loop within the system.

The PSA oxygen generating assembly includes two or more absorbing tanks 8 which are connected in parallel.

The electric control assembly provides a choice of three different types of power supplies including a rechargeable battery, a regulated power supply and a vehicle power supply; the electric control assembly further includes pressure & oxygen sensors 16, and a negative pressure sensor 17 so as to monitor system pressure, oxygen concentration and state of oxygen output to make sure supplying oxygen when inspiring and stop supplying oxygen when exhaling.

The heat dissipation assembly includes a temperature controller 14 so as to prevent the working temperature inside the oxygen generator from exceeding a threshold value.

The ventilating muffler is disposed in another separated space isolated by another partition board so as to exhaust nitrogen easily.

A fixed or detachable handle and belt lock catches 19 are disposed on the housing 1 for the convenience of carrying the whole oxygen generator easily.

1. A portable PSA oxygen generator comprising:
a housing, a fixing board, a partition board, and components including: an air filter assembly including a filter and an air-intaking muffler, an oil-free compressor, a control valve assembly, a PSA oxygen generating assembly including absorbing tanks and an ventilating muffler, an oxygen supply assembly including an oxygen tank, a pressure reducing valve and a filter, a heat dissipation assembly including a fan and a temperature controller, and an electric control assembly including a PCB board, pressure & oxygen sensors, a negative pressure sensor and a rechargeable battery; characterized in that, at least one fixing board is disposed inside the housing which divide an interior of the housing into one or more separated spaces, so that said components are disposed within said one or more separated spaces by the sides of the at least one fixing board.

2. The portable PSA oxygen generator according to claim 1, characterized in that, the oxygen generator comprises the heat dissipation assembly; the oil-free compressor and the control valve assembly are disposed in one of the separated spaces isolated by the partition board.

3. The portable PSA oxygen generator according to claim 1, characterized in that, the control valve assembly consists of at least four micro two-position two-way electromagnetic valves which are connected in parallel, or consists of one or more micro two-position five-way pilot-operated air control valves which are connected in parallel.

4. The portable PSA oxygen generator according to claim 1, characterized in that, the PSA oxygen generating assembly includes two or more absorbing tanks which are connected in parallel.

5. The portable PSA oxygen generator according to claim 1, characterized in that, the electric control assembly provides a choice of different types of power supplies including a rechargeable battery, a regulated power supply and a vehicle power supply.

6. The portable PSA oxygen generator according to claim 2, characterized in that, the heat dissipation assembly includes a temperature controller.

7. The portable PSA oxygen generator according to claim 2, characterized in that, the ventilating muffler is disposed in another separated space isolated by another partition board.

8. The portable PSA oxygen generator according to claim 1, characterized in that, a fixed or detachable handle and belt lock catches are disposed on the housing.
